(19) United States
(12) Patent Application Publication
(10) Pub. No.: US 2012/0323933 A1
(43) Pub. Date: Dec. 20, 2012

(54) DISPLAYING NOTIFICATIONS BASED ON IMPORTANCE TO THE USER

(75) Inventors: Tony Qizhen He, Kirkland, WA (US); Kerry David Woolsey, Duvall, WA (US); Marco Ferruccio Verdesca, Redmond, WA (US)

(73) Assignee: Microsoft Corporation, Redmond, WA (US)

(21) Appl. No.: 13/163,761

(22) Filed: Jun. 20, 2011

(51) Int. Cl. G06F 17/30

(52) U.S. Cl. 707/749; 707/E17.005

(57) ABSTRACT

Embodiments prioritize notifications relating to received communication items for display to a user of a computing device. For each received communication item, the computing device searches for related user data items such as calendar data, contacts, emails, and the like. Each of the user data items has a priority value. The computing device calculates a priority score for the notification based on the priority values associated with the related user data items. The notification is displayed among other notifications based on the calculated priority score relative to the priority scores of the other notifications. In some embodiments, the notifications include an ordered set of notifications displayed as tiles on a user interface of a mobile computing device.

### BACKGROUND

Existing computing devices receive communications from a variety of sources. For example, mobile telephones receive voice calls, voice messages, visual voice messages, text messages, and electronic mail messages. For each received communication, the mobile telephones generate notifications to the user such as visual, audible, or physical alerts (e.g., vibration). Some existing mobile telephones, however, do not integrate the notifications, which forces the user to navigate different applications to view and react to each of the notifications. Additionally, because not all notifications are of the same importance to the receiving user, the user has to view all the notifications to identify the notifications considered high priority by the user.

### SUMMARY

Embodiments of the disclosure organize notifications based on anticipated importance to the user. A computing device receives a communication item for a user of the computing device. User data items are searched based on the received communication item to identify related user data items. The user data items are associated with the user and each of the user data items has a priority value associated therewith. A notification is generated for the received communication item. The computing device calculates a priority score for the generated notification based on the priority values associated with the identified, related user data items. The generated notification is provided for display on the computing device based on the calculated priority score relative to priority scores of notifications corresponding to communication items previously received by the computing device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a computing device for displaying notifications to a user.

FIG. 2 is an exemplary flow chart illustrating operation of the computing device to order and display notifications based on calculated priority scores.

FIG. 3 is an exemplary diagram illustrating a mobile computing device displaying missed call notifications and a speed dial pad.

FIG. 4 is an exemplary diagram illustrating missed event notifications displayed on the mobile computing device.

Corresponding reference characters indicate corresponding parts throughout the drawings.

### DETAILED DESCRIPTION

Referring to the figures, embodiments of the disclosure enable notifications associated with communication items received by a computing device 102 to be prioritized for display to a user 104 of the computing device 102. In some embodiments, a priority score is calculated for one of the received communication items based on priority values 118 assigned to user data items 116 related to the received communication item.

Aspects of the disclosure enable the notifications of perceived or anticipated importance to the user 104 to be prominently displayed to the user 104. The notifications are also linked to the underlying communication items thus allowing the user 104 to quickly and easily consume and react to the communication items.

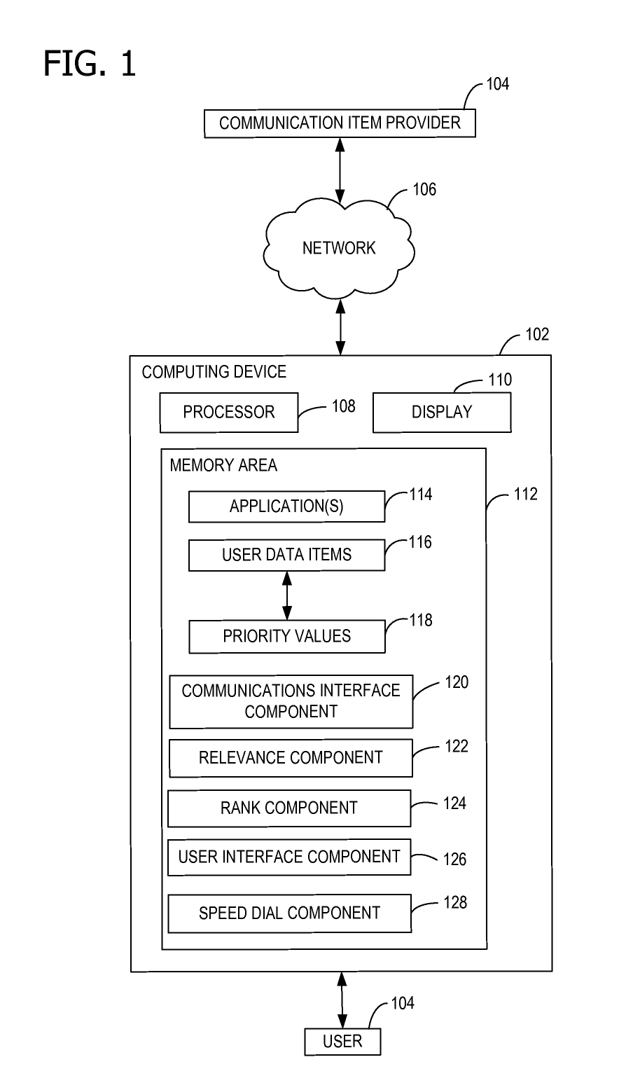

Referring again to FIG. 1, an exemplary block diagram illustrates the computing device 102 for displaying notifications to the user 104. In the example of FIG. 1, the computing device 102 associated with the user 104 represents a system for organizing notifications based on anticipated importance to the user 104. The notifications are generated from communication items received from a communication item provider 104 via a network 106 such as the Internet. Exemplary communication item providers 104 include mail servers, gateways, or any other device sending communication items to the computing device 102. Exemplary networks 106 include the Internet and public or private branch exchanges.

The computing device 102 represents any device executing instructions (e.g., as application programs, operating system functionality, or both) to implement the operations and functionality associated with the computing device 102. The computing device 102 may include a mobile computing device 302 or any other portable device. In some embodiments, the mobile computing device 302 includes a mobile telephone, laptop, tablet, computing pad, netbook, gaming device, and/or portable media player. The computing device 102 may also include less portable devices such as desktop personal computers, kiosks, and tabletop devices. Additionally, the computing device 102 may represent a group of processing units or other computing devices.

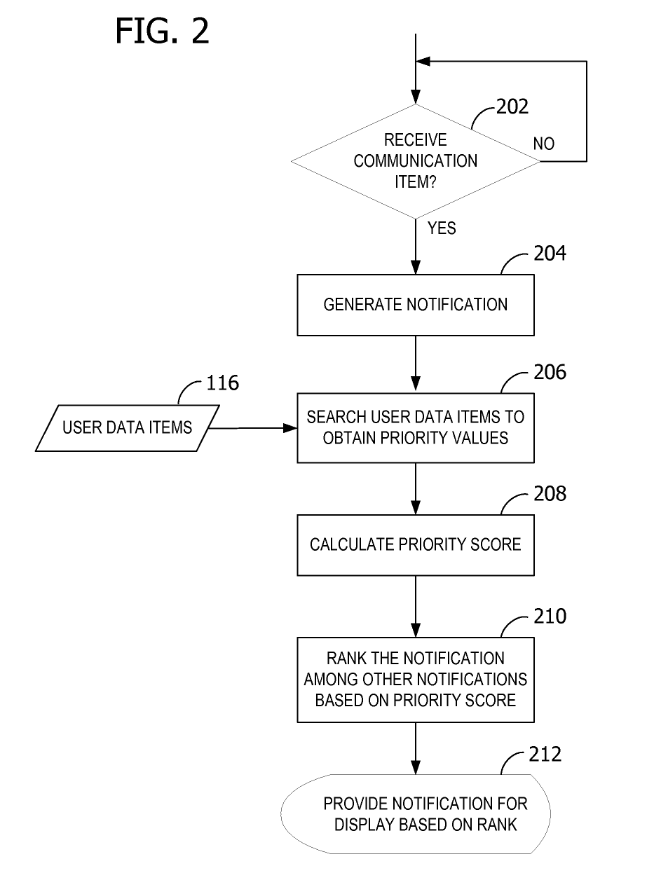

The computing device 102 has at least one processor 108, at least one display 110, and a memory area 112. The processor 108 includes any quantity of processing units, and is programmed to execute computer-executable instructions for implementing aspects of the disclosure. The instructions may be performed by the processor 108 or by multiple processors executing within the computing device 102, or performed by a processor external to the computing device 102. In some embodiments, the processor 108 is programmed to execute instructions such as those illustrated in the figures (e.g., FIG. 2).

The display 110 includes any component for providing information to the user 104 and/or receiving information from the user 104. For example, the display 110 includes any capacitive display and/or resistive display capable of sensing touch input from the user 104 or another object such as a stylus. While aspects of the disclosure are described with reference to the display 110 being a touch sensitive or touch screen display, embodiments of the disclosure are operable with any display. For example, aspects of the disclosure are operable with non-touch sensitive displays such as found on devices that have a full or partial keyboard available for data entry.

The computing device 102 further has one or more computer readable media such as the memory area 112. The memory area 112 includes any quantity of media associated with or accessible by the computing device 102. The memory area 112 may be internal to the computing device 102 (as shown in FIG. 1), external to the computing device 102 (not shown), or both (not shown).

The memory area 112 stores, among other data, one or more applications 114. The applications 114, when executed by the processor 108, operate to perform functionality on the computing device 102. Exemplary applications 114 include mail application programs, web browsers, calendar application programs, address book application programs, messaging programs, media applications, location-based services, search programs, and the like. The applications 114 may communicate with counterpart applications or services such as web services accessible via a network. For example, the applications 114 may represent downloaded client-side applications that correspond to server-side services executing in a cloud.

The memory area 112 further stores one or more user data items 116 associated with the user 104. Exemplary user data items 116 include one or more of the following: social networking activity items, group data items, calendar data items, contact data items, messaging data items, and call data items. The social networking activity items include, for example, likes or dislikes identified by the user 104, posts by the user 104, posts by the user 104 to a web page or account of another user, and the like. The group data items represents one or more of the user data items 116 that are grouped or categorized (e.g., work group, family group, etc.). The contact data items include information describing a contact of the user 104. The messaging data items include text messages, electronic mail messages, instant messages, and the like. The call data items include voice calls, video calls, voicemails, or other call information. In some aspects of the disclosure, the user data items 116 include any incoming and/or outgoing communication items.

Each of the user data items 116 has a priority value 118 associated therewith. The priority value 118 represents the interest or importance of the user data item 116 to the user 104. The priority values 118 may be assigned to each of the user data items 116, or assigned to one of a plurality of categories or types to which the user data items 116 are assigned. For example, the priority values 118 may be assigned to the user data items 116 based on one or more of the following category types: contact, group, calendar, text message, electronic mail message, voice call, and social networking

Each priority value 118 may be defined or adjusted by the user 104, an operating system executing on the mobile computing device 302, a vendor associated with one of the applications 114 executing on the mobile computing device 302, or a hardware vendor associated with the mobile computing device 302.

In some embodiments, the user 104 may explicitly adjust the priority values 118 for each of the user data items 116, or for a category or type associated with the user data items 116. For example, the user 104 may indicate a stronger interest in communication items containing meeting requests than communication items contain social networking updates. In this example, the user 104 assigns a higher priority value 118 to the category of user data items 116 associated with meeting requests than the priority value 118 associated with the category of user data items 116 associated with social networking updates.

Because the user data items 116 represent data associated with the user 104, aspects of the disclosure enable organization of notifications (and hence communication items) particular or customized to each user 104.

Table 1 below includes exemplary priority values 118 based on a category associated with each of the user data items 116. In Table 1, the priority values 118 indicate that the user 104 considers user data items 116 associated with contacts that are pinned (e.g., a priority value of 6) or assigned to a speed dial location (e.g., a priority value of 5) to be higher priority than user data items 116 associated with social networking.

TABLE 1
Exemplary Priority Values Assigned
to Categories of User Data Items.

| Category | Description | Score |
|---|---|---|
| Pinned contacts | Contacts that are pinned on a start | 6 |
| | screen or home screen | |
| Speed dial contacts | Contacts that are assigned to one | 5 |
| | of the speed dial locations | |
| Family group | Contacts included in the group | 4 |
| | Family | |
| Recent activity | 1. Contacts that are part of an | 3 |
| 1. Calendars | upcoming/passed meeting | |
| 2. Incoming/outgoing | 2. Contacts that have sent/received | |
| text message | a text message | |
| 3. Incoming/outgoing | 3. Contacts that have sent/received | |
| email | an email | |
| 4. Incoming/outgoing | 4. Contacts that have received an | |
| calls | outgoing/incoming call | |
| Groups | Contacts that are part of one or more | 2 |
| | group | |
| Social networking | 1. Contacts that have liked a post | 1 |
| (the following items | of the user or posted a comment to | |
| have the same priority) | the user | |
| 1. Like | 2. Contacts to whom the user has | |
| 2. Post | posted a comment or liked a post | |
| 3. Gaming friends | 3. Contacts that the user has | |
| | indicated as a friend for multi- | |
| | player gaming | |

In Table 1, the different types of user data items 116 listed in the recent activity category are assigned the same priority value 118. Similarly, the different types of user data items 116 listed in the social networking category are assigned the same priority value 118. Further, when calculating the priority score for a newly received communication item, aspects of the disclosure may limit the search for related user data items 116 to include only those user data items 116 received up to one hour before receipt of the newly received communication item.

In an example using the exemplary priority values 118 in Table 1, the user 104 has missed calls from a family member named Alina and a friend named Antonio. Both Alina and Antonio have left voice messages. To calculate the priority score for Alina, aspects of the disclosure search the user data items 116 for the name “Alina” and find that Alina is a pinned contact (e.g., priority value of 6), is one of the speed dial contacts (e.g., priority value of 5), and is a member of the group “Family” (e.g., priority value of 4). As such, in embodiments in which the priority score represents the sum of the individual priority values 118, the priority score for Alina is 6+5+4=15.

To calculate the priority score for Antonio, aspects of the disclosure search the user data items 116 for the name “Antonio” and find that Antonio is one of the speed dial contacts (e.g., priority value of 5), is a member of the group “Friend” (e.g., priority value of 4), sent a text message to the user 104 within the last hour (e.g., priority value of 3), and that the user 104 called Antonio within the last hour (e.g., priority value of 4). As such, in embodiments in which the priority score represents the sum of the individual priority values 118, the priority score for Antonio is 5+4+3+4=16.

As such, the notification associated with Antonio is ranked higher, or prioritized higher, than the notification associated with Alina. The notification associated with Antonio is then displayed in a graphical element located in the highest priority position (e.g., the top left of the user interface of the computing device 102).

The memory area 112 further stores one or more computer-executable components. Exemplary components include a communications interface component 120, a relevance component 122, a rank component 124, a user interface component 126, and a speed dial component 128. Operation of the components when executed is described below with reference to FIG. 2.

Referring next to FIG. 2, an exemplary flow chart illustrates operation of the computing device 102 to order and display notifications based on calculated priority scores. The operations illustrated in FIG. 2 may be performed by the computing device 102 or the mobile computing device 302. Alternatively or in addition, the operations illustrated in FIG. 2 may be performed by a cloud service that communicates with the computing device 102 to instruct the computing device 102 as to the selection and ordering of notifications to display. In such embodiments, the cloud service stores, or otherwise has access to, the user data items 116.

If a communication item for the user 104 is received by the computing device 102 at 202, a notification is generated for the received communication item at 204. As described above, the communication item includes any data intended for consumption by the user 104 (e.g., voice call, text message, electronic mail message, etc.). The notification includes any brief, redacted, or reduced summary of the received communication item (e.g., “missed call” or “new voicemail” or “1 text message from Antonio”). The computing device 102 searches the user data items 116 at 206 to identify or obtain the relevant priority values 118. In some embodiments, the computing device 102 identifies relevant, similar, or otherwise related user data items 116 that share a keyword, search term, category, or type with that of the received communication. For example, the computing device 102 may search the user data items 116 based on contact name, domain name, telephone number (or portion thereof, such as prefix), or keywords within the communication item.

The priority values 118 associated with the identified user data items 116 are then used to calculate the priority score for the notification at 208. The priority score represents the anticipated importance of the notification to the user 104. The priority score may be calculated in a plurality of ways including, but not limited to, summing the priority values 118, averaging the priority values 118, and calculating the median of the priority values 118. In general, the priority score may be calculated using any mathematical method for selecting or computing one value from a plurality of input values. In some embodiments, the priority values 118 may be weighted before being combined or analyzed to calculate the priority score.

At 210, the notification is ranked or otherwise compared relative to other notifications based on the calculated priority score relative to the priority scores of the other notifications. The other notifications represent communication items that have been previously received by the computing device 102. For example, the computing device 102 may have more notifications to display than are able to fit into the display 110. The computing device 102 selects the notifications to present to the user 104 based on the priority score. In some embodiments, notifications with high priority scores are more likely to be selected for display than notifications with low priority scores. For example, three of the notifications with the highest priority scores may be selected for display.

The ranking at 210 occurs as a function of the calculated priority score. For example, the ranking may include ordering the notifications based on their corresponding priority scores. In another example, the ranking may include performing any mathematical computation on the priority scores to produce the ordering.

At 212, the notification is provided for display based on the rank. If the rank indicates that the notification should be displayed, the notification is displayed to the user 104. If the rank indicates that other notifications have higher priority scores, the notification is not displayed but instead maintained by the computing device 102. When one of the displayed notifications is removed or otherwise no longer displayed (e.g., consumed by the user 104), the rank is updated and one of the notifications not currently displayed may now be selected for display.

The notification may be provided at 212 by generating an icon, tile, toast, or other graphical element representing the notification. The generated graphical element is displayed to the user 104 by the computing device 102. In some embodiments, the generated graphical element is one of a plurality of graphical elements ordered based on the priority scores corresponding thereto. The plurality of graphical elements represents an ordered set of the graphical elements.

The notifications may be displayed on a home screen, start screen, landing page, desktop, lock screen, or any other user interface element associated with the computing device 102. The notifications may be interactive at least in that the user 104 is able to select one or more of the notifications for consumption. Upon receiving a selection from the user 104 of at least one of the graphical elements displayed in the ordered set of graphical elements, the computing device 102 provides, to the user 104, the communication item corresponding to the selected graphical element. The computing device 102 may perform any action corresponding to the notification represented by the selected graphical element. For example, the computing device 102 may execute one of the application programs (e.g., an email program, a text message program, etc.) associated with the selected graphical element to display the corresponding communication item.

The computing device 102 may further remove the selected graphical elements from the displayed, ordered set of graphical elements after the user 104 has selected the graphical element. For example, the computing device 102 may scroll the remaining, displayed notifications to make room for the display of another notification.

In some embodiments, the computer-executable components illustrated in FIG. 1 may be executed to perform the operations illustrated in FIG. 2. For example, the communications interface component 120, when executed by the processor 108, causes the processor 108 to receive, by the computing device 102, one of the communication items for the user 104. The communications interface component 120 may further generate a notification for the received communication item. In some embodiments, the communications interface component 120 includes a network interface card and/or computer-executable instructions (e.g., a driver) for operating the network interface card. The relevance component 122, when executed by the processor 108, causes the processor 108 to search the user data items 116 based on the communication item received by the communications interface component 120 to identify related user data items 116. The rank component 124, when executed by the processor 108, causes the processor 108 to calculate a priority score for the generated notification based on the priority values 118 associated with the related user data items 116 identified by the relevance component 122.

The user interface component 126, when executed by the processor 108, causes the processor 108 to provide the generated notification for display on the computing device 102 based on the priority score, calculated by the rank component 124, relative to priority scores of notifications corresponding to communication items previously received by the computing device 102. In some embodiments, the user interface component 126 includes a graphics card for displaying data to the user 104 and receiving data from the user 104. The user interface component 126 may also include computer-executable instructions (e.g., a driver) for operating the graphics card. Further, the user interface component 126 may include the display 110 (e.g., a touch screen display) and/or computer-executable instructions (e.g., a driver) for operating the display 110. The user interface component 126 may also include one or more of the following to provide data to the user 104 or receive data from the user 104: speakers, a sound card, a camera, a microphone, a vibration motor, one or more accelerometers, a BLUETOOTH brand communication module, global positioning system (GPS) hardware, and a photoreceptive light sensor.

The speed dial component 128, when executed by the processor 108, causes the processor 108 to update speed dial settings based on the priority score calculated by the rank component 124 relative to the priority scores of notifications corresponding to communication items previously received by the computing device 102. For example, the priority scores may be based on the exemplary values in Table 1 above. The speed dial settings represent, for example, correlations or assignments between contacts and a limited quantity of speed dial locations. In some embodiments, updating the speed dial settings includes, in some embodiments, re-assigning at least one speed dial location to a contact associated with the received communication.

In some embodiments, the speed dial component 128 further maintains a counter representing a quantity of incoming and outgoing communication items for each of a plurality of contacts. The contacts are ranked, sorted, or otherwise ordered based on the maintained counters and/or priority scores. The speed dial component 128 re-assigns one or more of the speed dial locations based on the ranking so that the contacts with whom the user 104 communicates with the most are assigned to the speed dial locations.

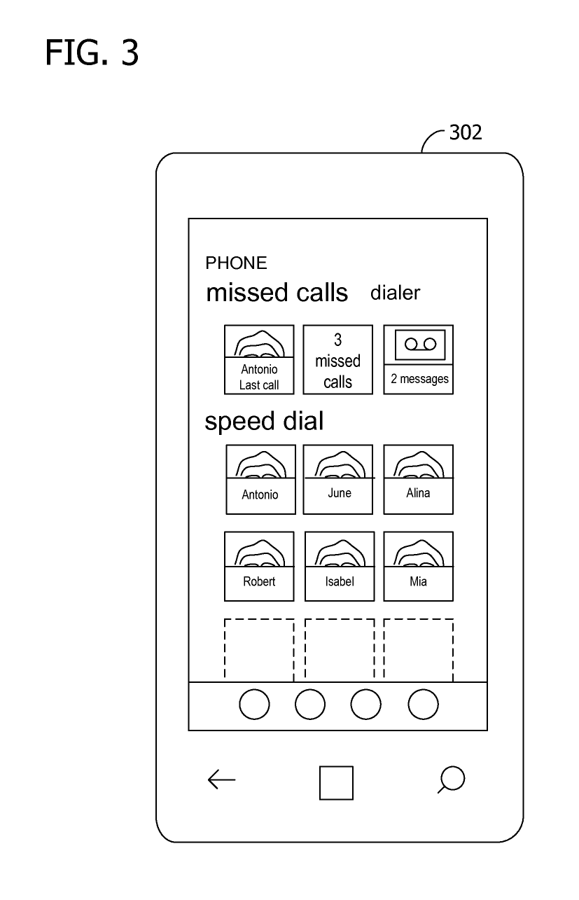

Referring next to FIG. 3, an exemplary diagram illustrates the mobile computing device 302 displaying missed call notifications and a speed dial pad. The notifications are displayed in one portion of a user interface of the mobile computing device 302, while the speed dial pad is displayed in another portion of the user interface. The notifications may be represented by any graphical element. Further, the placement of the graphical elements may be static or dynamic. In embodiments contemplating static placement, the location of each graphical element is fixed to leverage muscle memory of the user 104. For example, the graphical element corresponding to voice messages is always in the same position in the user interface. In embodiments contemplating dynamic placement, the locations of the graphical elements varies based on, for example, the ordering of the notifications as described herein. In some embodiments, the notification with the highest priority score is displayed on the left, followed to the right by the notification with the second highest priority score, which is followed to the right by the notification with the third highest priority score.

In some embodiments, the portion of the user interface displaying the notifications includes three tiles. In one tile, an image (if available) of the contact associated with the last incoming or outgoing communication item is displayed in the background of the tile. The label “last call” may also be displayed in the foreground of this tile, along with the name of the contact in some embodiments. In the example of FIG. 3, the first tile shows an image of Antonio, the name “Antonio,” and the words “Last call” indicating that the user 104 last communicated with Antonio.

In another tile, the number of missed calls is shown. If the missed calls are each from the same contact, an image (if available) of the contact is displayed in the background of the tile. The number of missed calls from the contact, along with the contact name, is displayed in the foreground of the tile. If each of the missed calls is not from the same contact, the number of missed calls is displayed. In the example of FIG. 3, the second tile shows the words “3 missed calls” to indicate that the user 104 has missed three calls from at least two contacts.

In another tile, the number of voice messages is shown. If there are no voice messages, the tile is disabled, or not displayed. In the example of FIG. 3, the third tile displays a voice mail icon and the word “2 messages” indicating that the user 104 has two voice messages.

In the portion of the user interface displaying the speed dial pad, each of the speed dial assignments is shown in a separate tile. When the user 104 selects one of the tiles having an assigned contact, the mobile computing device 302 dials the number associated with the contact and the tile. In some embodiments, the speed dial assignments are set by the user 104. The user 104 sets the speed dial assignments by selecting an open tile (e.g., a tile without a contact assigned thereto), selects one of the contacts, and selects the contact information (e.g., telephone number, email address, etc.) of the selected contact that the user 104 wants associated with the selected tile. After setting the speed dial assignment, when the user 104 selects the tile again the mobile computing device 302 will initiate communication with the contact via the contact information assigned to the tile by the user 104.

In other embodiments, the speed dial assignments are dynamically assigned by the mobile computing device 302, an operating system executing on the mobile computing device 302, an application program executing on the mobile computing device 302, a cloud service, or other entity. In such embodiments, the speed dial pad may be populated with the contacts that are communicated with most often. For example, every time the user 104 receives or initiates communication with one of the contacts, a counter associated with the contact is incremented. The contacts are sorted, ranked, or ordered based on the values in the counters. The speed dial assignments are then updated based on the order of the contacts to show the most frequent contacts at the top of the speed dial pad, followed by the less frequent contacts at the bottom. If two or more contacts have the same counter value, the contact with the more recent communication is ranked higher.

In the example of FIG. 3, the speed dial pad indicates that the user 104 communicates frequently with Antonio, June, and Alina, and less frequently with Robert, Isabel, and Mia.

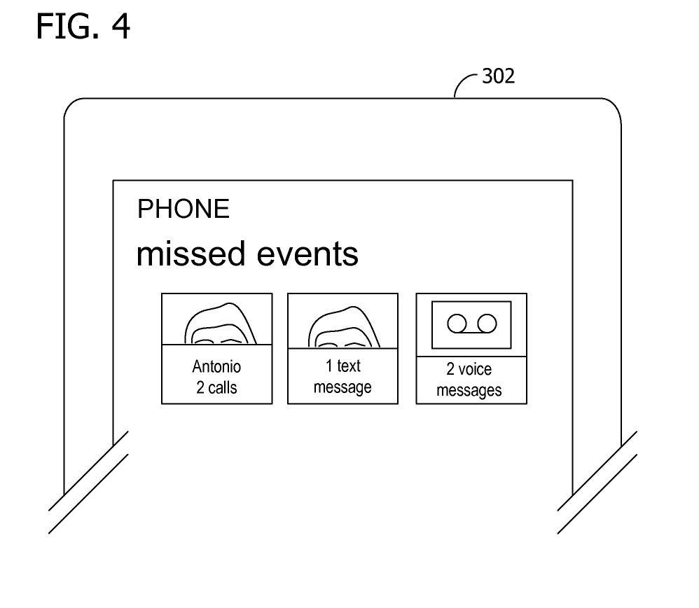

Referring next to FIG. 4, an exemplary diagram illustrates missed event notifications displayed on the mobile computing device 302. The missed event notifications relate to any type of communication item. In the example of FIG. 4, the missed event notifications include a tile for missed calls, a tile for missed text messages, and a tile for voice messages.

In some embodiments, the missed event notifications are dynamic in that the content of each tile changes as communication items are received and/or as the user 104 consumes the communication item associated with the displayed notifications. In such embodiments, any telephone event may be displayed in any of the three tiles, and the telephone events are prioritized as a function of the priority scores associated with the telephone events. The notifications may scroll to the left as the user 104 selects one of the displayed notifications.

In some embodiments, the dynamic tiles illustrated in FIG. 4 may be prioritized as next described. Voice mails are shown in the leftmost tile if there are any unread or unheard messages. Missed calls (and the quantity thereof) are shown in either the leftmost tile or the middle tile. If each of the missed calls are from the same contact, an image (if available) of the contact is also displayed in the tile. In some embodiments, if there are at least two missed calls from at least two contacts (or other caller), the number of missed calls is displayed in the leftmost tile, while the images of the contacts and/or telephone numbers of the caller are displayed in the other two tiles. If there are no voice mails or missed calls (e.g., within the last 48 hours), the three tiles display the last three incoming or outgoing calls including an image of the contacts and/or telephone numbers of the callers. If there are no recent incoming or outgoing calls (e.g., within the last 48 hours), the three tiles include a shortcut to a call history.

In another embodiment, the dynamic tiles illustrated in FIG. 4 may be ordered by timestamps associated with the telephone events. The dynamic tiles may also be scrollable by the user 104. For example, the user 104 may scroll the entire list of notifications by pivoting left and/or right on the displayed tiles.

In still another embodiment, the leftmost tile of the dynamic tiles illustrated in FIG. 4 may represent missed calls for which a voice message is available. The middle tile may represent a total number of missed calls (e.g., those with and without voice messages) from contacts known to the user 104. The rightmost tile may represent a total number of missed calls from callers who are not contacts of the user 104.

### ADDITIONAL EXAMPLES

Aspects of the disclosure are not limited to prioritizing notifications from known contacts of the user 104. Rather, aspects of the disclosure are operable with communication items received from any entity known or unknown to the user 104.

At least a portion of the functionality of the various elements in FIG. 1 may be performed by other elements in FIG. 1 or an entity (e.g., processor, web service, server, application program, computing device, etc.) not shown in FIG. 1.

In some embodiments, the operations illustrated in FIG. 2 may be implemented as software instructions encoded on a computer readable medium, in hardware programmed or designed to perform the operations, or both. For example, aspects of the disclosure may be implemented as a system on a chip.

While no personally identifiable information is tracked by aspects of the disclosure, embodiments have been described with reference to data monitored and/or collected from users 104. In such embodiments, notice is provided to the users 104 of the collection of the data (e.g., via a dialog box or preference setting) and users 104 are given the opportunity to give or deny consent for the monitoring and/or collection. The consent may take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media store information such as computer readable instructions, data structures, program modules or other data. Computer storage media exclude propagated data signals. Communication media typically embody computer readable instructions, data structures, program modules, or other data in a modulated data signal such as a carrier wave or other transport mechanism and include any information delivery media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for calculating the priority score for the notification based on perceived importance to the user 104, and exemplary means for assigning the priority values 118 to the user data items 116 based on relevance to the user 104.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for organizing notifications based on anticipated importance to the user, said system comprising:
a memory area associated with a mobile computing device, said memory area storing user data items associated with a user of the mobile computing device, each of said user data items having a priority value associated therewith;
a processor programmed to:
receive a communication item;
search the user data items stored in the memory area based on the received communication item to identify related user data items;
generate a notification for the received communication item;
calculate a priority score for the generated notification based on the priority values associated with the identified, related user data items;
rank the generated notification among other notifications as a function of the calculated priority score to create an ordered set of notifications, said other notifications corresponding to communication items previously received by the mobile computing device; and
display to the user the ordered set of notifications on the mobile computing device.

2. The system of claim 1, wherein the user data items comprise one or more of the following: social networking activity items, group data items, calendar data items, contact data items, messaging data items, and call data items.

3. The system of claim 1, wherein the user data items relate to incoming and/or outgoing communication items.

4. The system of claim 1, wherein the communication items comprise one or more of the following: voice calls, voice mails, text messages, and electronic mail messages.

5. The system of claim 1, further comprising means for calculating the priority score for the notification based on perceived importance to the user.

6. The system of claim 1, further comprising means for assigning the priority values to the user data items based on relevance to the user.

7. A method comprising:
receiving, by a computing device, a communication item for a user of the computing device;
searching user data items based on the received communication item to identify related user data items, said user data items being associated with the user, each of said user data items having a priority value associated therewith;
generating a notification for the received communication item;
calculating, by the computing device, a priority score for the generated notification based on the priority values associated with the identified, related user data items; and
providing the generated notification for display on the computing device based on the calculated priority score relative to priority scores of notifications corresponding to communication items previously received by the computing device.

8. The method of claim 7, wherein providing the generated notification for display comprises:
comparing the calculated priority score to the priority score of the notifications corresponding to communication items previously received by the computing device; and
updating the display of notifications on the computing device based on comparison.

9. The method of claim 7, further comprising ranking the generated notification among the other notifications based on the calculated priority score.

10. The method of claim 7, further comprising receiving, from the user, the priority values for one or more of the user data items.

11. The method of claim 7, wherein providing the generated notification for display comprises providing the generated notification for display as a graphical element in an ordered set of graphical elements on a home screen of the computing device.

12. The method of claim 11, further comprising:
receiving a selection from the user of one of the graphical elements in the ordered set of graphical elements; and
providing for display to the user the communication item corresponding to the selected graphical element.

13. The method of claim 12, further comprising removing the selected graphical element from the ordered set of graphical elements displayed on the computing device.

14. The method of claim 7, further comprising assigning the priority values to the user data items based on a category type associated with each of the user data items.

15. The method of claim 14, wherein assigning the priority values to the user data items comprises assigning the priority values to the user data items based on one or more of the following category types: contact, group, calendar, text message, electronic mail message, voice call, and social networking.

16. The method of claim 7, wherein providing the generated notification for display on the computing device comprises generating a graphical element for display in an ordered set of graphical elements each corresponding to a notification, said ordered set of graphical elements being scrollable via interaction with the user.

17. One or more computer storage media embodying computer-executable components, said components comprising:
a communications interface component that when executed causes at least one processor to receive, by a computing device, a communication item for a user of the computing device, said communications interface component further generating a notification for the received communication item;
a relevance component that when executed causes at least one processor to search user data items based on the communication item received by the communications interface component to identify related user data items, said user data items being associated with the user, each of said user data items having a priority value associated therewith;
a rank component that when executed causes at least one processor to calculate, by the computing device, a priority score for the generated notification based on the priority values associated with the related user data items identified by the relevance component;
a user interface component that when executed causes at least one processor to provide the generated notification for display on the computing device based on the priority score, calculated by the rank component, relative to priority scores of notifications corresponding to communication items previously received by the computing device; and
a speed dial component that when executed causes at least one processor to update speed dial settings based on the priority score, calculated by the rank component, relative to the priority scores of notifications corresponding to communication items previously received by the computing device.

18. The computer storage media of claim 17, wherein the speed dial component updates the speed dial settings by re-assigning at least one speed dial location to a contact associated with the received communication item.

19. The computer storage media of claim 17, wherein the speed dial component further:
maintains a counter representing a quantity of incoming communications and outgoing communications for each of a plurality of contacts;
ranks the contacts based on the maintained counters; and
re-assigns one or more speed dial locations based on the ranked contacts.

20. The computer storage media of claim 17, wherein the user interface component provides the generated notification and the speed dial settings for display on one or more of the following on the computing device: a home screen, a start screen, a landing page, a desktop, and a lock screen.
